(19) United States
(12) Patent Application Publication
(10) Pub. No.: US 2015/0193348 A1
(43) Pub. Date: Jul. 9, 2015

(54) HIGH-PERFORMANCE DATA CACHE SYSTEM AND METHOD

(71) Applicant: Shanghai XinHao Micro Electronics Co. Ltd., Shanghai (CN)

(72) Inventor: Chenghao Kenneth Lin, Shanghai (CN)

(21) Appl. No.: 14/411,062

(22) PCT Filed: Jun. 25, 2013
(86) PCT No.: PCT/CN2013/077892

§ 371 Date: Dec. 23, 2014

(30) Foreign Application Priority Data
Jun. 27, 2012 (CN) 201210228069.0

(51) Int. Cl. G06F 12/08; G06F 12/12

(52) U.S. Cl. CPC G06F 12/0862; G06F 12/0806; G06F 12/128; G06F 2212/621; G06F 2212/6026; G06F 2212/69

(57) ABSTRACT

A high-performance data cache system and method is provided for facilitating operation of a processor core. The method includes examining instructions to generate stride length of base register value corresponding to every data access instruction; based on the stride length of base register value, calculating possible a data access address of the data access instruction to be executed next time; based on the calculated the possible data access address of the data access instruction to be executed next time, prefetching data and filling the data to cache memory before the processor core accesses the data. The processor core may access directly the needed data from the cache memory almost every time, thus getting very high cache hit rate.

### TECHNICAL FIELD

The present invention generally relates to computer, communication, and integrated circuit technologies.

### BACKGROUND ART

In general, cache is used to duplicate a certain part of main memory, so that the duplicated part in the cache can be accessed by a processor core or a central processing unit (CPU) core in a short amount of time and thus to ensure continued pipeline operation of the processor core.

Currently, cache addressing is based on the following ways. First, an index part of an address is used to read out a tag from a tag memory. At the same time, the index and an offset part of the address are used to read out contents from the cache. Further, the tag from the tag memory is compared with a tag part of the address. If the tag from the tag memory is the same as the tag part of the address, called a cache hit, the contents read out from the cache are valid. Otherwise, if the tag from the tag memory is not the same as the tag part of the address, called a cache miss, the contents read out from the cache are invalid. For a multi-way set associative cache, the above operations are performed in parallel on each set to detect which way has a cache hit. Contents read out from the set with the cache hit are valid. If all sets experience cache misses, contents read out from any set are invalid. After a cache miss, cache control logic fills the cache with contents from lower level storage medium.

Cache miss can be divided into three types: compulsory miss, conflict miss, and capacity miss. Under existing cache structures, except a small amount of pre-fetched contents, compulsory miss is inevitable. But, the current prefetching operation carries a not-so-small penalty. Further, while a multi-way set associative cache may help reduce conflict misses, the number of way set associative cannot exceed a certain number due to power and speed limitations (e.g., the set-associative cache structure requires that contents and tags from all cache sets addressed by the same index are read out and compared at the same time). Further, with the goal for cache memories to match the speed of the processor core, it is difficult to increase cache capacity. Thus, multiple layers of cache are created, with a lower layer cache having a larger capacity but a slower speed than a higher layer cache.

### DISCLOSURE OF INVENTION

### Technical Problem

Current modern cache systems normally comprise multiple layers of cache in a multi-way set associative configuration. New cache structures such as victim cache, trace cache, and prefetching (putting the next cache block into a cache buffer while fetching a cache block or under a prefetch instruction) have been used to address certain shortcomings. However, with the widening gap between the speed of the processor and the speed of the memory, the existing cache architectures, especially with the various cache miss possibilities, are still a bottleneck in increasing the performance of modern processors or computing systems.

### SOLUTION TO PROBLEM

### Technical Solution

The disclosed methods and systems are directed to solve one or more problems set forth above and other problems.

One aspect of the present disclosure includes a method for facilitating operation of a processor core coupled to a first memory containing data and a second memory with a faster speed than the first memory. The processor core is configured to execute a segment of instructions having at least one instruction accessing the data from the second memory using a base address. The method includes examining instructions to generate stride length of base register value corresponding to every data access instruction; based on stride length of the base register value, calculating a possible data access address of the data access instruction to be executed next time; based on the calculated possible data access address of the data access instruction to be executed next time, prefetching data and storing data in the second memory.

Another aspect of the present disclosure includes a method for facilitating operation of a processor core coupled to a first memory containing data and a second memory with a faster speed than the first memory. The processor core is configured to execute a segment of instructions having at least one instruction accessing the data from the second memory using a base address. The method includes examining the segment of instructions to extract instruction information containing at least data access instruction information and last base register updating instruction information; filling the data from the first memory to the second memory based on the track corresponding to the segment of instructions after execution of an instruction last updating the base register used by the at least one instruction accessing the data.

Another aspect of the present disclosure includes a method for facilitating operation of a processor core coupled to a first memory containing data, a second memory with a faster speed than the first memory and a third memory with a faster speed than the second memory. The processor core is configured to execute a segment of instructions having at least one instruction accessing the data from the third memory. The method includes examining instructions to generate stride length of base register value corresponding to every data access instruction; based on stride length of the base register value, calculating possible data access addresses of the data access instruction to be executed next time; based on calculated possible data access addresses of the data access instruction to be executed next time, prefetching data and storing data in the third memory; moving out data from the third memory to store in the second memory because of the contents replaced from the third memory; moving out data from the second memory to write back to the first memory because of the contents replaced from the second memory.

Other aspects of the present disclosure can be understood by those skilled in the art in light of the description, the claims, and the drawings of the present disclosure.

### ADVANTAGEOUS EFFECTS OF INVENTION

### Advantageous Effects

The disclosed systems and methods may provide fundamental solutions to caching structure used in digital systems. Different from the conventional cache systems using a fill after miss scheme, the disclosed systems and methods fill instruction and data caches before a processor executes an instruction or accessing a data, and may avoid or substantially hide compulsory misses. That is, the disclosed cache systems are integrated with pre-fetching process, and eliminate the need for the conventional cache tag matching processes. Further, the disclosed systems and methods essentially provide a fully associative cache structure thus avoid or substantially hide conflict misses and capacity misses. The disclosed systems and methods can also operate at a high clock frequency by avoiding tag matching in time critical cache accessing. Other advantages and applications are obvious to those skilled in the art.

### BRIEF DESCRIPTION OF DRAWINGS

### Description of Drawings

FIG. 1 illustrates an exemplary data prefetching processor environment incorporating certain aspects of the present invention;

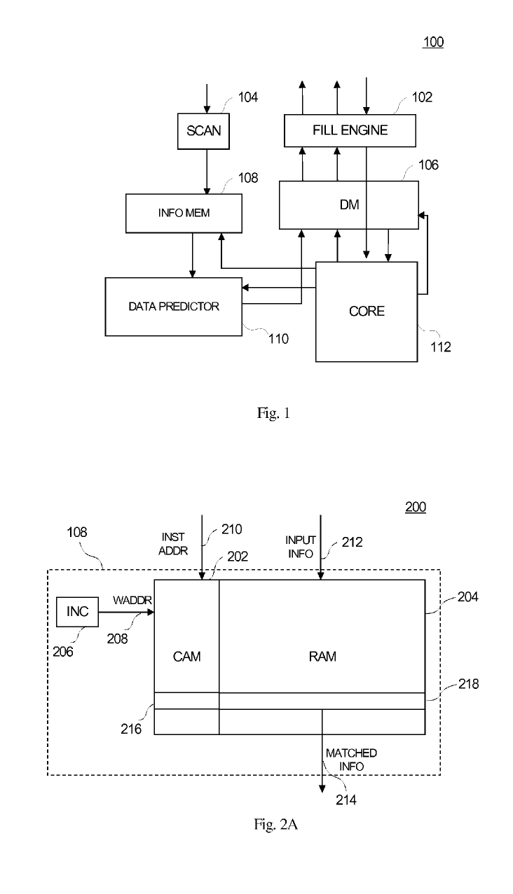

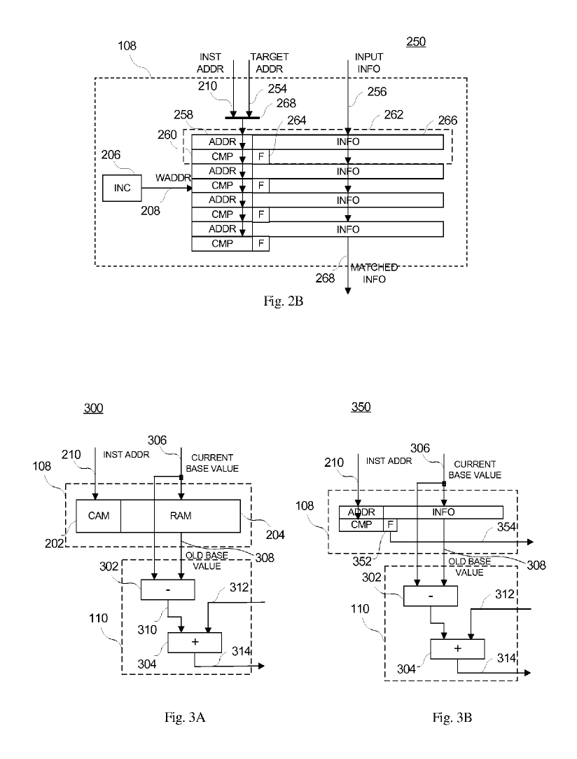

FIG. 2A illustrates an exemplary instruction information memory consistent with the disclosed embodiments;

FIG. 2B illustrates another exemplary instruction information memory consistent with the disclosed embodiments;

FIG. 3A illustrates an exemplary data predictor consistent with the disclosed embodiments;

FIG. 3B illustrates another exemplary data predictor consistent with the disclosed embodiments;

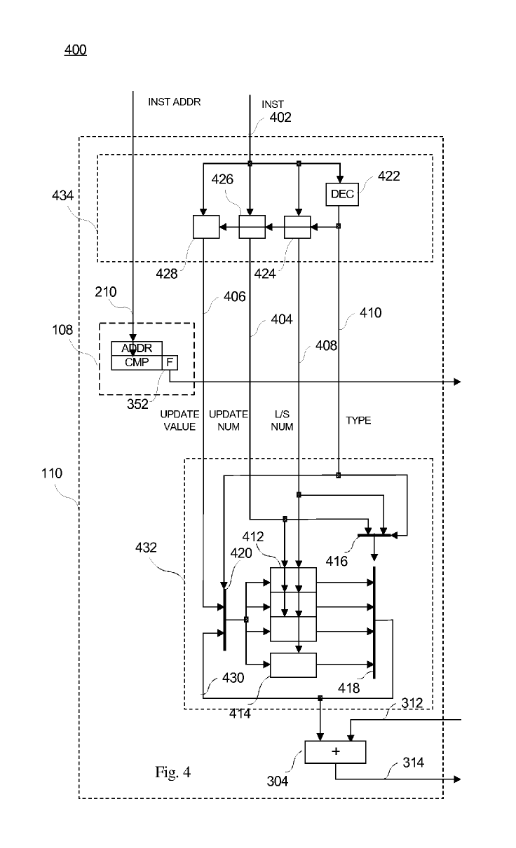

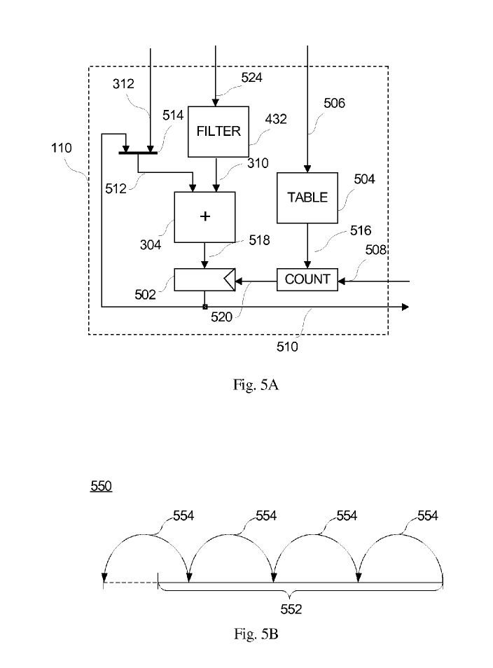

FIG. 4 illustrates another exemplary data predictor to calculate stride length of a base register value consistent with the disclosed embodiments;

FIG. 5A illustrates another exemplary data predictor consistent with the disclosed embodiments;

FIG. 5B illustrates an exemplary data predictor calculating the number of data prefetching times consistent with the disclosed embodiments;

FIG. 6 illustrates an exemplary data prefetching based on the instructions stored in advance consistent with the disclosed embodiments;

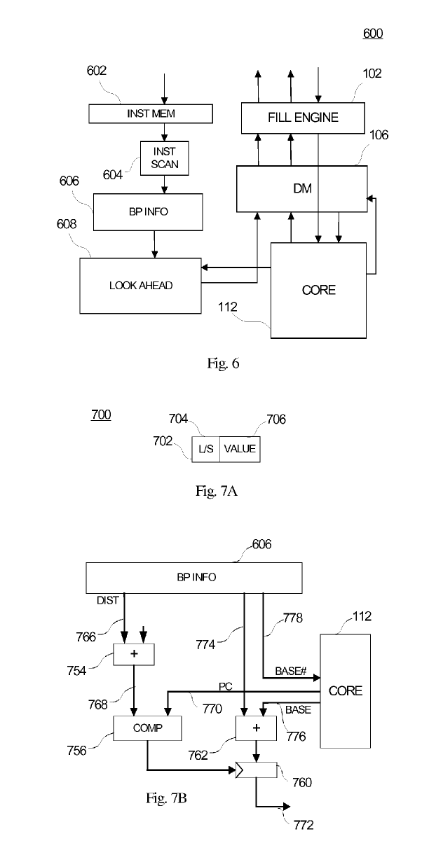

FIG. 7A illustrates an exemplary entry format of data access instructions in a base address information memory consistent with the disclosed embodiments;

FIG. 7B illustrates an exemplary time point calculation of data addressing address in a look ahead module consistent with the disclosed embodiments;

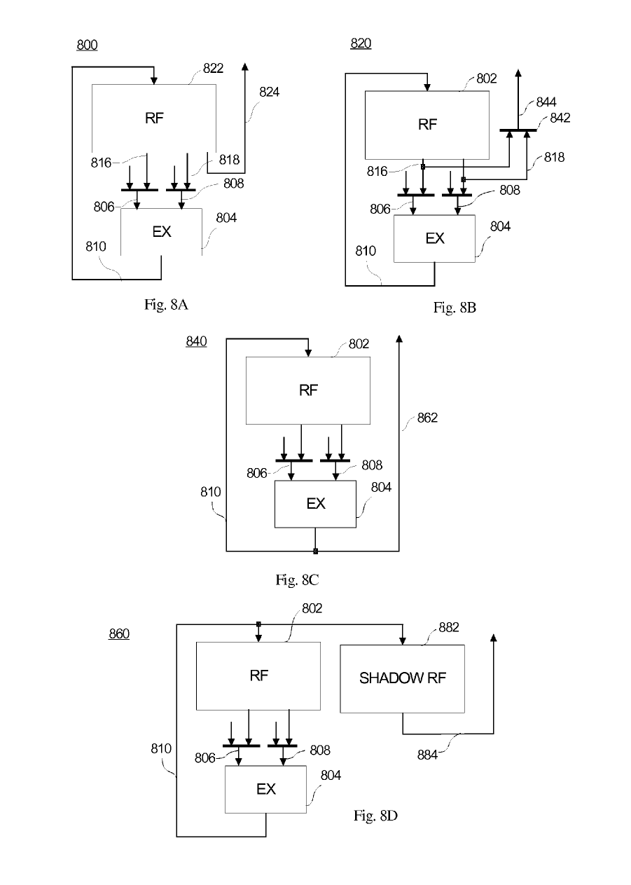

FIG. 8A illustrates an exemplary base register value obtained by an extra read port of a register consistent with the disclosed embodiments;

FIG. 8B illustrates an exemplary base register value obtained by a time multiplex mode consistent with the disclosed embodiments;

FIG. 8C illustrates an exemplary base register value obtained by a bypass path consistent with the disclosed embodiments;

FIG. 8D illustrates an exemplary base register value obtained by an extra register file for data prefetching consistent with the disclosed embodiments;

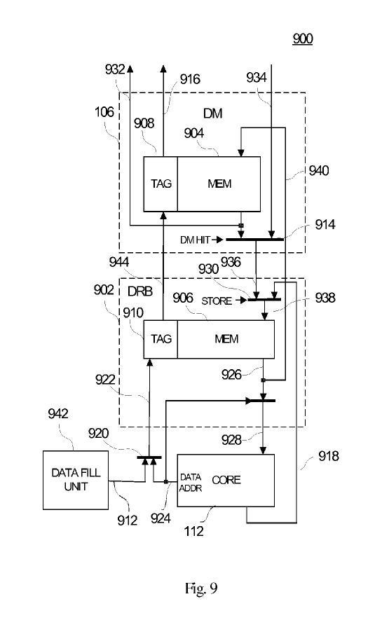

FIG. 9 illustrates an exemplary data prefetching with a data read buffer consistent with the disclosed embodiments; and

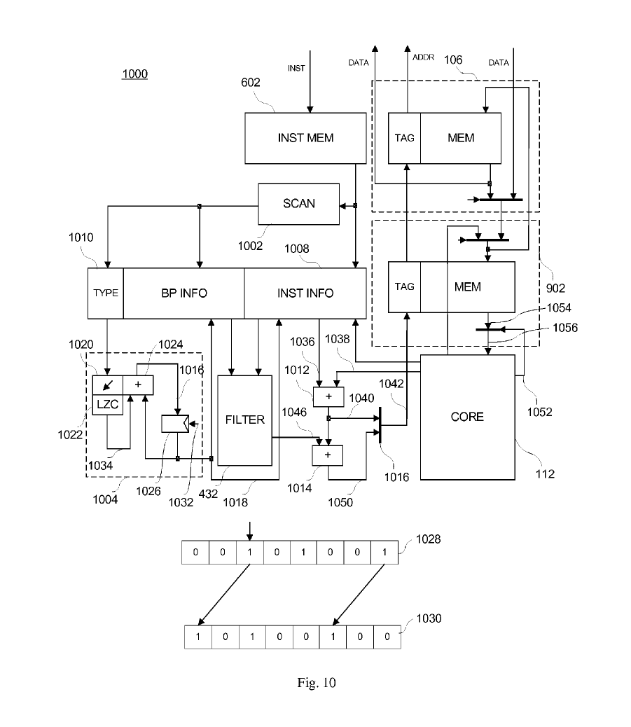

FIG. 10 illustrates an exemplary complete data prefetching consistent with the disclosed embodiments.

### BEST MODE FOR CARRYING OUT THE INVENTION

### Best Mode

FIG. 10 illustrates an exemplary preferred embodiment(s).

### MODE FOR THE INVENTION

### Mode for Invention

Reference will now be made in detail to exemplary embodiments of the invention, which are illustrated in the accompanying drawings. The same reference numbers may be used throughout the drawings to refer to the same or like parts.

A cache system including a processor core is illustrated in the following detailed description. The technical solution of the invention may be applied to cache system including any appropriate processor. For example, the processor may be General Processor, central processor unit (CPU), Microprogrammed Control Unit (MCU), Digital Signal Processor (DSP), Graphics Processing Unit (GPU), System on Chip (SOC), Application Specific Integrated Circuit (ASIC), and so on.

FIG. 1 shows an exemplary data prefetching processor environment 100 incorporating certain aspects of the present invention. As shown in FIG. 1, computing environment 100 may include a fill engine 102, a scanner 104, a data memory 106, an instruction information memory 108, a data predictor 110, and a processor core 112. It is understood that the various components are listed for illustrative purposes, other components may be included and certain components may be combined or omitted. Further, the various components may be distributed over multiple systems, may be physical or virtual, and may be implemented in hardware (e.g., integrated circuitry), software, or a combination of hardware and software.

The data memory 106 and instruction information memory 108 may include any appropriate storage devices such as register, register file, synchronous RAM (SRAM), dynamic RAM (DRAM), flash memory, hard disk, Solid State Disk (SSD), and any appropriate storage device or new storage device of the future. The data memory 106 may function as a cache for the system or a level one cache if other caches exist, and may be separated into a plurality of memory segments called blocks (e.g., memory blocks) for storing data to be accessed by processor core 112.

The processor core 112 may execute data access instructions such as load instructions or store instructions. For processor core 112 to execute a data access instruction, the processor core 112 may execute data addressing by adding an offset to a base address. The processor core 112 first needs to read the instruction from the lowest level memory. As used herein, the level of a memory refers to the closeness of the memory in coupling with a processor core. The closer to the processor core, the higher the level. Further, a memory with a higher level is generally faster in speed while smaller in size than a memory with a lower level.

The processor core 112 may also execute branch instructions. For processor core 112 to execute a branch instruction, at the beginning, the processor core 112 may determine the address of the branch target instruction, and then decide whether the branch instruction is executed based on branch conditions. The processor core 112 may also execute other appropriate instructions.

Scanner 104, instruction information memory 108, data predictor 110 and fill engine 102 are used to fill data to be accessed by the processor core 112 into the data memory 106. Thus, processor core 112 may access data in very low cache miss rate from the data memory 106. As used herein, the term ‘fill’ means to move instruction/data from a lower level memory to a higher level memory, and the term ‘memory access’ means that processor core 112 reads from or writes to the closest memory (i.e., data memory 106). In addition, based on any appropriate address, fill engine 102 may obtain data or data blocks from the lower level memory to fill into data memory 106.

The scanner 104 may examine every instruction executed by processor core 112 and extract certain information, such as instruction type, base register number, and address offset, etc. An instruction type may include load instruction, store instruction, branch instruction, other instructions, etc. The address offset may include a data access address offset, a branch target address offset, and so on. The extracted information and the base register value corresponding to the data access instruction outputted by processor core 112 constitute the related information about this instruction that is sent to the instruction information memory 108.

The instruction information memory 108 stores information about the instructions recently executed by processor core 112. Every entry of the instruction information memory 108 stores a matching pair including an instruction address and the related information about this instruction. The instruction address is its own address of the instruction.

When the scanner 104 examines a data access instruction, the instruction address of the data access instruction is sent to the instruction information memory 108 to perform matching operations. If the matching operation is unsuccessful, a matching pair including the instruction address and the related information corresponding to the address is created in the instruction information memory 108. If the matching operation is successful, a difference between the current base register value and the old base register value stored in the instruction information memory 108 is calculated by data predictor 110. The base register value stored in the instruction information memory 108 is updated by the current base register value. The possible data addressing addresses may be calculated in advance for next one or more data access operations by the calculated difference. Thus, before processor core 112 executes the data access instruction next time, fill engine 102 may prefetch one or more possible data addressing addresses to data memory 106.

In addition, the scanner 104 may also calculate a branch target instruction address based on the branch target address offset of the extracted branch instruction, and judge whether this branch instruction is loop back (the branch target instruction address is less than the branch instruction address). For example, the instruction address of the branch instruction adds the branch target address offset to calculate the branch target instruction address. For example, when the branch target address offset is a negative value, it is judged that this branch instruction is loop back. Thus, this simple judgment determines whether the data access instruction corresponding to the matching pair stored in the instruction information memory 108 is located within the scope of the branch. For example, when a data access instruction address is greater than or equal to the branch target instruction address and is less than the branch instruction address, it is judged that the data access instruction is located within the scope of the branch. For processor core 112 to execute the loop back branch instruction, the possible data addressing addresses for next one or more data access operations may be calculated when the data access instructions are located within the scope of the branch. And the corresponding data is prefetched.

In some situations, for example, when processor core executes a loop code with unchanged stride length of a data addressing address, the possible data addressing addresses predicted by technical solutions of this invention are actual data addressing addresses. Therefore, the data may be filled into data memory 106 before processor core 112 executes the data access instructions, so that processor core 112 may execute read/write operations without waiting, thus improving processor performance.

According to technical solutions of the invention, the instruction information memory 108 may be constituted by at least one content addressable memory (CAM). The instruction information memory 108 may be also constituted by any appropriate memory devices, such as registers that implement similar functionality. When processor core 112 runs in real-time, scanner 104 scans the instruction being obtained by processor core 112 to extract instruction type and sends the instruction address of the data access instruction to the instruction information memory 108 to execute a matching operation. If the matching operation is successful, a signal that represents the matching operation is successful is outputted; if the matching operation is unsuccessful, an entry containing the instruction address is created in the instruction information memory 108, and a signal that represents the matching operation is unsuccessful is outputted. When the matching pair is created in full instruction information memory 108, an entry in the instruction information memory 108 can be replaced by using least recently used (LRU) replacement policy or least frequently used (LFU) replacement policy.

FIG. 2A illustrates an exemplary instruction information memory 200 consistent with the disclosed embodiments. As shown in FIG. 2A, the main part of the instruction information memory 108 is constituted by content addressable memory (CAM) 202 and random access memory (RAM) 204. It may also be constituted by any appropriate memory devices. CAM 202 stores instruction addresses of data access instructions. RAM 204 stores base register values corresponding to the instructions.

When the scanner 104 examines that the instruction being obtained by processor core 112 is a data access instruction, instruction address 210 of the data access instruction is sent to CAM 202. Matching operations are performed on the instruction address against each instruction address entry stored in CAM 202. If the matching operation is successful (such as entry 216), the content 214 (the base register value of the data access instruction executed last time corresponding to the instruction address) corresponding to the entry (such as entry 216) in RAM 204 is outputted.

When the matching operation is unsuccessful, the instruction address is stored in the entry pointed by write pointer 208 in CAM 202. At the same time, the base register value 212 sent by processor core 112 is stored in the entry pointed by write pointer 208 in RAM 204. Thus, a matching pair is constituted by the instruction address and the related information about the instruction. Then, incrementer 206 adds 1 to write pointer 208 to make write pointer 208 point to the next entry. Based on the difference of process architectures, time points of the base register values sent by processor core 112 are different. But the time interval (or clock periodic interval) of the corresponding data access instruction obtained by processor core 112 is relatively fixed. Therefore, the correct base register value may be written to the corresponding entry. Thus, when processor core 112 executes the data access instruction again and the instruction address corresponding to the instruction is also stored in the instruction information memory 108, the matching operation is successful and the corresponding content (the stored base register value) of the entry is outputted.

FIG. 2B illustrates another exemplary instruction memory 250 consistent with the disclosed embodiment. As shown in FIG. 2B, the main part of the instruction information memory 108 is constituted by registers and comparators. For example, for entry 266, address register 258 stores an instruction address; information register 262 stores a base register value of the data access instruction corresponding to the instruction address executed last time; flag register 264 stores a flag that represents whether the corresponding entry is located within the range of the current branch instruction (for example, ‘1’ represents that the data access instruction corresponding to the entry is located within the range of the current branch instruction, ‘0’ represents that the data access instruction corresponding to the entry is located outside the range of the current branch instruction); comparators 260 may compare an input value with the address value in register 258 and output the result of the comparison, such as greater than, less than, or equal to.

Selector 268 may select the instruction address 210 and branch target instruction address 254 based on instruction type extracted by scanner 104. When the instruction type extracted by scanner 104 is a data access instruction, selector 268 selects the instruction address 210 as an output that is sent to the comparator in various entries to perform comparison operations. When the result of the comparison is ‘equal’, the matching pair of the data access instruction is found in the instruction information memory 108. If the matching operation is successful, the content (the base register value of the data access instruction executed last time corresponding to the instruction address) of the information register in the corresponding entry is outputted to port 268. If the matching operation is unsuccessful, the instruction address is stored in the address register of the entry pointed by write pointer 208. At the same time, the base register value sent by processor core 112 is stored in the information register of the same entry. Thus, a matching pair is constituted by the instruction address and the base register value. Then, incrementer 206 adds 1 to write pointer 208 to make write pointer 208 point to the next entry.

When the instruction type extracted by scanner 104 is a loop back branch instruction, selector 268 selects branch target instruction address 254 as an output that is sent to the comparator in various entries to perform comparison operations. When the result of a comparison is ‘great than or equal to’ or ‘less than or equal to’, it is judged whether the data access instruction corresponding to every entry is located within the scope of the branch (the branch target address is less than or equal to the data access instruction address and is less than or equal to the branch instruction address) of the branch instruction (current branch). The value of the tag register corresponding to the entry of the data access instruction address within the scope of branch is set as ‘1’. The tag register value corresponding to the entry of the data access instruction address outside the branch scope is set as ‘0’. In addition, when the instruction type extracted by scanner 104 is a branch instruction but is not a loop back branch instruction, the tag register value in every entry is set as ‘0’.

FIG. 3A illustrates an exemplary data predictor 300 consistent with the disclosed embodiments. As shown in FIG. 3A, the main part of data predictor 110 is constituted by adders. As shown in previous described example, when scanner 104 examines a data access instruction, the instruction address 210 of the data access instruction is sent to CAM 202 in the instruction information memory 108 to perform matching operations on each instruction address entry stored in CAM 202. If the matching operation is successful, the base register value 308 corresponding to the entry stored in RAM 204 is sent to data predictor 110.

The subtractor 302 in data predictor 110 implements subtraction function, that is, the current base register value 306 (the base register value corresponding to the data access instruction) sent by processor core 112 minus the old base register value 308 sent by the instruction information memory 108 gets the difference of base register value 310. The difference 310 is stride length of the data addressing address when the data access instruction is executed twice. In some situations, particularly, when processor core executes a loop code with unchanged stride length of the data addressing address, the data addressing address value is equal to the current data addressing address value plus the stride length when the data access instruction is executed next time.

The adder 304 in data predictor 110 is used to add the difference to the data addressing address 312 of the current data access instruction sent by processor core 112. Thus, the possible data addressing address 314 obtained by adder 304 for executing the data access instruction next time is sent to data memory 106 to perform an address matching operation. If the matching operation is unsuccessful, fill engine 102 prefetches the data addressing address. Otherwise, no prefetch operation is performed.

FIG. 3B illustrates another exemplary data predictor 350 consistent with the disclosed embodiments. As shown in FIG. 3B, data predictor 110 in FIG. 3B is the same as data predictor 110 in FIG. 3A. Instruction information memory 108 in FIG. 3B is different from instruction information memory 108 in FIG. 3A. The structure of the instruction information memory 108 in FIG. 3B is the same as the instruction information memory 108 in FIG. 2B. As shown in previous example, when the scanner 104 examines a data access instruction, the instruction address 210 of the data access instruction is sent to various address registers in the instruction information memory 108 to perform matching operations. If the matching operation is successful, the base register value 308 stored in the corresponding information register is sent to data predictor 110. The tag value 354 corresponding to tag register 352 is sent to fill engine 102.

The subtractor 302 and the adder 304 in data predictor 110 is used to calculate the possible data addressing address 314 for executing the data access instruction next time based on current base register value 306, old base register value 308, and current data addressing address 312. The possible data addressing address 314 is sent to data memory 106 to perform address matching operations. The matching result determines whether the data corresponding to the address is stored in data memory 106. At the same time, the data addressing address 314 is sent to fill engine 102.

The fill engine 102 determines whether the data corresponding to the received data addressing address 314 is prefetched based on received tag value 354 and an address matching result in data memory 106. If tag value 354 is ‘1’ and the address matching operation is unsuccessful in data memory 106, fill engine 102 prefetches the data addressing address. Otherwise, no prefetch operation is performed. Because the data access instructions corresponding to the entries whose tag value 354 are ‘1’ are located within the scope of current branch, in certain embodiments, the prefetch operation is only performed for the possible data access addresses next time of the data access instruction within the scope of current branch, that is, the prefetch operation is only performed for the data access operation executed possibly next time, thus reducing data pollution.

In addition, the example in FIG. 3B may also be improved in the followings. When fill engine 102 receives the tag value 354 and the address matching result in data memory 106, fill engine 102 only stores temporarily the data addressing address that needs to be prefetched. Whereas, the instruction information memory 108 stores not only the access instruction related information, but also the address information of the loop back branch instruction corresponding to the scope of current branch. Thus, when the scanner 104 examines that the current instruction is a branch instruction, the instruction address may compare with the address information of the loop back branch instruction in instruction information memory 108. If the result of the comparison is equal, the current branch instruction is a loop back branch instruction, then fill engine 102 performs a prefetch operation for the temporary data addressing address, thus further reducing data pollution.

In the method for computing the stride length of the base register in FIG. 3A or FIG. 3B, when a data access instruction is executed at the first time, the base register value is stored to the instruction information memory 108; when the data access instruction is executed at the second time, the data accessing address of the data access instruction to be executed at the third time is calculated by deducting the stored base register value from the current base register value. Other prediction methods may be used to calculate the stride length of the base register value at an earlier time when the base register value does not need to be stored. Thus, when a data access instruction is executed at the first time, the data accessing address of the data access instruction executed at the second time may be calculated.

FIG. 4 illustrates another exemplary data predictor 400 to calculate stride length of a base register value consistent with the disclosed embodiments. As shown in FIG. 4, data predictor 110 includes an extractor 434, a filter for stride length of a base register value 432, and an adder 304. Extractor 434 includes a decoder 422 and extractors 424, 426, and 428. The extractor 434 is used to examine instruction 402 being obtained by processor core 112. The decoder 422 obtains instruction type 410 after decoding the instruction. Then target register number 404, changing value of a register 406 and base register number of the data access instruction 408 in register updating instruction are extracted from the instruction 402 based on the result of decode operation. In general, register number, register value change and other values in the different types of the instructions may be in the different positions of an instruction word. Therefore, the information may be extracted from the corresponding positions in the instruction word based on the decoded result of the instruction type.

In general, the base register used by the data access instruction also belongs to a register file. A changing value of any base register may be obtained directly or calculated by recording the changing values of all registers in the register file. In other cases, for example, if the base register does not belong to a register file, the similar method may be used, that is, the changing value of any base register may be obtained directly or calculated by recording the changing values of all registers in the register file and all base registers.

In certain embodiments, an instruction type decoded by the decoder may include data access instruction and register updating instruction. A register updating instruction refers to the instruction for updating any register value of a register file. When a change of a target register value in the register updating instruction uses an immediate value format, the immediate value is the changing value 406 corresponding to the register value; if updating the register value by other ways, the changing value 406 may be also calculated.

The instruction information memory 108 does not store the base register value, only including registers (or memory devices) that are used to store instruction addresses, comparators that are used to match with input instruction address 210, and tag register 352. It is similar with previous described case that the instruction information memory 108 may match with input instruction address to determine whether the corresponding data access instruction is located within the scope of loop back branch. Thus, the data may be prefetched for the data access instructions only located within the scope. Of course, in the specific implementations, the instruction information memory 108 can also be omitted, thus the data may be prefetched for all data access instructions.

The filter for stride length of a base register value 432 includes register file 412, 414 and selector 416, 418, 420. The input of selector 416 includes target register number 404 of the register updating instruction and base register number 408 of the data access instruction. A selection signal is instruction type 410. If the current instruction is a register updating instruction, the selector 416 selects a target register number 404 of the register updating instructions as an output to control the selector 418; if the current instruction is a data access instruction, the selector 416 selects a base register number 408 of the data access instructions as an output to control the selector 418.

Inputs of selector 418 are outputs of register file 412 and register file 414. The output 430 is sent to one input port of selector 420. Another input port of selector 420 is a changing value of register value 406. A selection signal is instruction type 410. If the current instruction is a register updating instruction, the selector 420 selects a changing value of register value 406 as an output to send to register file 412 and register file 414; if the current instruction is a store instruction in a data access instruction, the selector 420 selects output 430 sent by selector 418 as an output to send to register file 412 and register file 414.

The register file 412 controls the output value of selector 420 written by various registers by target register number 404 in the register updating instruction sent by extractor 434 and the zero-clearance of various registers by base register number 408 in the data access instruction sent by extractor 434. The register file 414 controls the base register number 408 in the data access instruction sent by extractor 434. The signal may act as write enable to control the output value of selector 420 written by various registers in register file 414.

Based on the different types of the instructions examined by the scanner, the operations of a filter for stride length of a base register value 432 are illustrated in the following paragraphs.

When the extractor 434 examines that the current instruction is a register updating instruction, the change of a register value 406 is extracted in the instruction. The selector 420 selects the change as the output to write to the corresponding target register addressed by target register number 404 of the instruction in register file 412. Thus, the stride length of the register value may be stored in register file 412.

When the extractor 434 examines that the current instruction is a data access instruction, the selector 416 selects the base register number of the instruction as an output to control selector 418. The register output in register file 412 and register file 414 corresponding to the output of the base register is selected as stride length of the register value of the data access instruction 430. At the same time, the selector 416 controls the zero-clearance of the corresponding register contents in register file 412.

In addition, if the data access instruction is an instruction that stores register values to main memory, the selector 420 selects stride length of the register value 430 outputted by register file 412 as an output to write to the corresponding register in register file 414, thus storing temporarily the stride length of change. If the data access instruction is the instruction that loads values from main memory to a register, selector 418 selects the output of the corresponding temporarily storing register in register file 414 as output 430 to send to selector 420, and writes to the register addressed by the register number in register file 412 after the selection, thus restoring the old storing temporarily stride length of change to the corresponding register.

The register file 412 stores stride length of various registers. The register file 414 stores temporarily stride length of change corresponding to temporary replaced register value. The filter 432 ensures to output stride length of the register (the base register) corresponding to the data access instruction when processor core 112 executes a data access instruction, thus implementing the function of subtractor 302 in FIGS. 3A and 3B.

Then, the following steps are similar as previous described example. Adder 304 adds data addressing instruction 312 to the stride length of base register value 430, thus obtaining the possible data access address 314 when the data addressing instruction is executed next time. Thus, the stride length of the base register value is calculated by filter 432 at an earlier time. When a data access instruction is executed at the first time, the data accessing address of the data access instruction to be executed at the second time may be calculated.

In certain embodiments, the method for calculating the stride length of the base register value, after obtaining the stride length of the base register value, may calculate a data addressing address when the data access instruction is executed next time. In addition, when performing the data access operation every time, current data segment including needed data is filled into data memory 106, and next data segment is prefetched and filled into data memory 106 to perform a data prefetch operation with fixed length. The data predictor may be improved to calculate multiple data addressing addresses for the data access instruction executed multiple times after obtaining the stride length of the base register value. Thus, more data may be prefetched, further improving the performance of the processor. FIG. 5A illustrates another exemplary data predictor 500 consistent with the disclosed embodiments. It is understood that the disclosed components or devices are for illustrative purposes and not limiting, certain components or devices may be omitted.

As shown in FIG. 5A, filter 432 and adder 304 of data predictor 110 are the same as these two devices in FIG. 4. Input 524 of the filter 432 includes input 404, 406, 408 and 410 of filter 432 in FIG. 4. The difference is that an extra register 502 is used to latch an out of adder 304, and latch value 510 is used to replace the output of data addressing address 314 in FIG. 3A. Another input of the adder 304 in FIG. 3A is from the data addressing address 312 of current data access instruction of processor core 112. Another input 512 of the adder 304 in FIG. 4 is selected from data addressing address 312 and latch value 510 of register 502 by selector 514.

In addition, a lookup table 504 and a counting module with the latch function 516 are also included in FIG. 5A. The lookup table 504 may find the times of appropriate data prefetching corresponding to all data access instructions in the scope of the branch instruction based on the scope of the current branch of input back loop (the number of branch back loop instructions and addresses) 506 and the average access memory latency (fill latency), and send the times to counting module 516 to give the times of data prefetching to the data access instruction within the scope of the branch. The counting module 516 may count a number based on a prefetch feedback signal sent by fill engine 102 and output the corresponding control signal to control latch 502. The prefetch feedback signal may represent that fill engine 102 starts to prefetch certain data. The prefetch feedback signal may also represent that fill engine 102 completes prefetching certain data. The prefetch feedback signal may also represent any other appropriate signal.

In general, based on the average access memory latency, the number of the executed instructions may be determined during waiting time of accessing memory once. If the number of instructions within the scope of the branch is larger than the number of executed instructions of the corresponding accessing memory once, the data addressing address next time needs to be prefetched to cover access memory latency when executing the data access instruction; if the number of instructions within the scope of the branch is larger than a half of the number of executed instructions of the corresponding accessing memory once, the data addressing addresses next two time need to be prefetched to cover access memory latency when executing the data access instruction; other circumstances follow the same pattern. Thus, the number of prefetching times may be determined based on the scope of the current branch by storing the different number of data prefetching times corresponding to the scope of the current branch of input back loop in the lookup table 504.

FIG. 5B illustrates an exemplary data predictor 550 calculating the number of data prefetching times consistent with the disclosed embodiments. As shown in FIG. 5B, segment 552 represents the length of fill latency. Arc line 554 refers to a time interval of the same instruction executed twice when the branch is successful for a loop back branch instruction. In certain embodiments, the filling time for accessing memory once is larger than the time for exciting instructions within the scope of the same branch three times and less than the time for executing these instructions four times. Therefore, if prefetching data four times for the data access instruction within the scope of the branch before executing a loop back branch instruction, the needed data for executing the data access instruction is filled to cover completely time latency caused by cache miss of the data access instruction.

When extractor 434 examines a data access instruction with related information stored in the instruction information memory 108, selector 514 selects the data addressing address 312 from processor core 112 as input 512 of adder 304. Thus, the adder 304 is the same as the adder 304 in FIG. 3A. The adder 304 may calculate the possible data addressing address 518 for executing the same data access instruction next time. After being latched, the possible data addressing address 518 may act as data accessing address 510 to send to data memory 106. An address matching operation is then performed to determine whether the data corresponding to the instruction is stored in data memory 106. Thus, it is determined whether fill engine 102 prefetches the data addressing address. If the address matching operation is unsuccessful, fill engine 102 prefetches the data addressing address. Otherwise, fill engine 102 does not prefetch the data addressing address.

The lookup table 504 outputs the number of the times needed to be prefetched to counting module 516 based on the scope of the current input branch 506. The initial value of the counting module 516 is ‘0’. The value of the counting module 516 increases ‘1’ after receiving feedback signal 508 sent from fill engine 102 every time, and outputs control signal 520 to control register 502 at the same time. The selector 514 selects data addressing address 510 outputted by register 502 as output 512 to send to adder 304. At that time, input 310 is unchanged. Therefore, the output of adder 304 is obtained by adding stride length of the base register to data addressing address prefetched last time (the first time), that is, new (the second time) prefetched data addressing address. The data addressing address controlled by control signal 520 is written to register 502. And the data addressing address outputs as data addressing address 510 to send to data memory 106. An address matching operation is performed to determine whether the data corresponding to the instruction is stored in data memory 106. Thus, it is determined whether fill engine 102 prefetches the data addressing address. If the address matching operation is unsuccessful, fill engine 102 prefetches the data addressing address. Otherwise, fill engine 102 does not prefetch the data addressing address.

The counting module 516 adds ‘1’ each time after receiving feedback signal 508 sent from fill engine 102 until the value of counting module 516 is equal to the number of prefetching times sent by lookup table 504. At this time, the write operation of register 502 is terminated by control signal. Thus, the total number of the addressing addresses generated is the number of prefetching times outputted by lookup table 504, and more data is prefetched.

When extractor 434 examines the data access instruction next time, if previous prefetching data is still stored in data memory 106, only data corresponding to the last data addressing address from multiple data addressing addresses outputted by register 502 this time may not be in data memory 106 due to multiple data having been prefetched. Therefore, only one datum is needed to be prefetched. If previous prefetching data is not stored in data memory 106, prefetch operations follow the steps in the previous described example.

Thus, the different number of prefetching times may be assigned based on the scope of branch. For example, when access memory latency is fixed, if the scope of branch is relatively large, a time interval of the same instruction executed twice in the scope of branch is relatively long. Therefore, the number of prefetching times needed to cover memory access latency is small. If the scope of branch is relatively small, a time interval of the same instruction executed twice in the scope of branch is relatively short. Therefore, the number of prefetching times needed to cover memory access latency is large. The lookup table 504 may be created based on this rule.

The disclosed embodiments may predict the data addressing addresses of the data access instructions located in the loop and prefetch data corresponding to the predicted addresses before executing these instructions next time. Thus, it helps reduce waiting time caused by cache miss and improve the performance of the processor. An instruction buffer is used to store the instructions to be executed possibly soon. The scanner 104 examines the instructions and finds data access instruction in advance to extract the base register number. The base register value is obtained to calculate the data addressing instruction of the data access instruction when updating the base register at the last time before executing the data access instruction. Thus, before executing the data access instruction, data corresponding to the data access address is prefetched to cover waiting time caused by data miss. FIG. 6 illustrates an exemplary data prefetching 600 based on the instructions stored in advance consistent with the disclosed embodiments.

As shown in FIG. 6, in certain embodiments, instruction memory 602 is used to store the instructions to be executed possibly by the processor core. The different devices may be used to implement instruction memory 602 based on different applications or available hardware resources and/or processor architectures. For example, in certain processor architecture, each time an instruction cache loads instruction, a segment of instructions is loaded. The segment of instructions consists of multiple instructions including the needed instruction. Thus, the instruction next to the needed instruction in the segment of instructions is the instruction to be executed possibly by the processor core soon. Therefore, the instruction memory 602 may be constituted by a row of an instruction buffer. A second example, in certain processor architecture, the segment of instructions corresponding to a loop code just executed is stored in a specific instruction memory (e.g. a loop code memory) for executing the loop next time. Thus, when executing the loop code next time, the instruction stored in the loop code memory is the instruction to be executed possibly by processor core. Therefore, the instruction memory 602 may be constituted by the loop code memory. A third example, the instruction memory 602 may be constituted by an extra memory device. It is used to store the instruction to be executed possibly by processor core, which is determined by any appropriate method. Without loss of generality, the instruction memory 602, as used herein, is an independent memory device. When the instruction memory 602 is constituted by other devices, the situations are similar.

The instruction scanner 604 is used to examine the instructions in the instruction memory 602 and extract instruction information to send to and stored in base address information memory 606. The extracted instruction information includes at least the information of the data access instruction and the information of the last register updating instruction. A look ahead module 608 is used to analyze information in base address information memory 606. For every data access instruction, the look ahead module 608 determines the position that causes the last base address updating instruction, and judges whether the base address is updated based on the address of the current instruction being executed by processor core. If the base address is updated, the data addressing address of the data access instruction is calculated and sent to data memory 106 to perform a matching operation. If the matching operation is unsuccessful, the data memory 106 sends the data addressing address to fill engine 102 to perform a prefetch operation. If the matching operation is successful, no prefetch operation is performed.

It is noted that the instruction scanner 604 is an independent device, but the instruction scanner 604 and the scanner 104 in previous described example may be the same scanner according to the different application situations.

In certain embodiments, the position of the data access instruction and the position of the instruction of the base register value corresponding to the last updating data access instruction are obtained by scanning and analyzing the instruction outputted by instruction memory 602. Thus, the instruction interval number between the instruction of the last updating base register value and the data access instruction is calculated and stored in the base address information memory 606. It is used to determine the time point for calculating the data addressing address. FIG. 7A illustrates an exemplary entry format 700 of the data access instruction in the base address information memory consistent with the disclosed embodiments.

As shown in FIG. 7A, the entry format in the base address information memory has only one type, that is, the entry format 702 corresponding to the data access instruction. The entry format 702 may include a load/store flag 704 and a value 706. The load/store flag 704 is the instruction type decoded by the scanner 604. The value 706 is the instruction interval number stored in the base address information memory 606. For example, if a data access instruction is the seventh instruction in an instruction block and the last updating the base register instruction is the third instruction in an instruction block, the value 706 is ‘−4’ for the data access instruction. Thus, the base register value is updated when a value of a program counter sent by processor core 112 is 4 less than the address of the data access instruction. The data addressing address is calculated by the method.

When getting to the time point for calculating data addressing address, the data addressing address may be calculated by adding an address offset to the base register value. The address offset uses an immediate value format in the instruction. Therefore, the address offset may be obtained directly from instruction memory 602. The address offset may also be extracted and stored in the base address information memory 606 when instruction scanner 604 examines the instruction. Then the address offset may be obtained from the base address information memory 606 when it is used. The address offset may also be obtained by any other appropriate method.

FIG. 7B illustrates an exemplary time point calculation of data addressing address in a look ahead module consistent with the disclosed embodiments. As shown in FIG. 7B, instruction interval number 766 corresponding to the data access instruction outputted by the base address information memory 606 is sent to adder 754. Anther input of the adder 754 is the position offset of the data access instruction in the instruction block. The adder 754 adds the position offset of the data access instruction to instruction interval number 766 to obtain position of the last updating base register instruction 768. The position 768 is sent to comparator 756. Another input of comparator 756 is instruction address 770 outputted by processor core 112. The result of the comparison is sent to the register to control the updating of the register value.

In addition, the base address information memory 606 outputs an address offset 774 of the data access instruction and base address register number 778. The base address register number is sent to the processor core 112 to obtain the corresponding register value 776. The obtained register value 776 is sent to adder 762. The address offset is directly sent to adder 762. Thus, the adder 762 may calculate and generate data addressing address.

When the value of the position 768 is equal to the instruction address 770 outputted by processor core 112, it represents the value corresponding to base address register is (updated) being updated. At this time, the result calculated by the adder 762 is the data addressing address of the data access instruction, that is, the current data addressing address sent to data memory 106.

The base register value is calculated by the processor core 112 and stored to a register in the processor core 112. The base register value may be obtained by multiple methods, for example, an extra read port of a register in the processor core 112, a time division multiplexing read port of a register in the processor core 112, a bypass path in the processor core 112, or an extra register file for data prefetching.

In general, the base register value is generated by execution unit (EX) in modern processor architecture. A register file stores the values of various registers including the base register in general architecture. The register value outputted by the register file or the value from other sources constitutes an input value of EX in the processor core. The register value outputted by the register file or the value from other sources constitutes an input value of EX. The two input values are operated by the EX, and the result of the operation is written back to register file. For illustrative purposes, there are two inputs and one output in the EX in certain embodiments. Other EXs with more (or less) inputs and more outputs are the similar with the EX in certain embodiments. As used herein, two register value outputted by register file may be the values from the same register or from the different registers. The result of the operation may be written back to the register that has the same source as the two registers or the register that has the different source from the two registers.

FIG. 8A illustrates an exemplary base register value 800 obtained by an extra read port of a register consistent with the disclosed embodiments. As shown in FIG. 8A, the operation process, that is, input value 806 and input value 808 are operated by EX 804 and the result 810 is written back to register file 822, is the same as the process in general processor architecture. The difference is that register file 822 has one more read port 824 than register file in general processor architecture. Thus, when getting to the time point for calculating data addressing address, the corresponding base register value is read out by the read port 824 to calculate the data addressing address.

FIG. 8B illustrates an exemplary base register value 820 obtained by a time multiplex mode consistent with the disclosed embodiments. As shown in FIG. 8B, the operation process, that is, input value 806 and input value 808 are operated by EX 804 and the result 810 is written back to register file 822, is the same as the process in general processor architecture. The difference is that the output 806 and output 808 from register file are also sent to selector 842, and then the result selected by selector 842 is outputted as the base register value 844. Thus, after the base register value is updated, if at least one input of the following instruction operands corresponding to EX 804 is not from register file, a read port of the register corresponding to the input value outputs the base register value; or if at least one input is the base register value, register value 816 or 818 is the base register value. The selector 842 selects the base register value as output 844 to calculate the data addressing address.

FIG. 8C illustrates an exemplary base register value 840 obtained by a bypass path consistent with the disclosed embodiments. As shown in FIG. 8C, the operation process, that is, input value 806 and input value 808 are operated by EX 804 and the result 810 is written back to register file 822, is the same as the process in general processor architecture. The difference is that the result 810 is not only written back to register file 822 but also sent out by bypass path 862. Thus, when EX 804 is performing the operation of updating the base register value, the result of the operation is the updated base register value. Therefore, the value sent by the bypass path 862 is the needed base register value to calculate the data addressing address. The bypass path method needs to know the correct time point that generates the result of the operation 810. The time point may be determined by the value 774 in FIG. 7A. As shown in FIG. 7A, if the value 774 is ‘−4’, when processor core 112 executes the fourth instruction before the data access instruction, the result of the operation outputted by EX 804 is the needed base register value.

FIG. 8D illustrates an exemplary base register value obtained by an extra register file for data prefetching consistent with the disclosed embodiments. As shown in FIG. 8D, the operation process, that is, input value 806 and input value 808 are operated by EX 804 and the result 810 is written back to register file 822, is the same as the process in general processor architecture. The difference is that there is an extra register file 882 that is a shadow register file of the old register file. All write values of the base register of the old register file are written to the corresponding register of register file 882 at the same time. Thus, all updating operations for the base register in the old register file are reflected to register file 882. Therefore, when getting to the time point for calculating the data addressing address, the base register value 884 may be read out from register file 882 to calculate the data addressing address. In physical implementation, register file 882 may be located in any appropriate position inside the processor core or outside the processor core.

In certain embodiments, a data read buffer that placed between data memory 106 and processor core 112 is used to store temporarily new prefetching data. When processor core 112 executes data access instruction, at the beginning, the needed data is searched from data read buffer. If the data does not exist, the needed data is searched from data memory 106. The data replaced from data read buffer is stored in data memory 106. FIG. 9 illustrates an exemplary data prefetching 900 with a data read buffer consistent with the disclosed embodiments. It is understood that the disclosed components or devices are for illustrative purposes and not limiting, certain components or devices may be omitted.

As shown in FIG. 9, the main part of both data memory 106 and data read buffer 902 is constituted by a memory that stores address tags and another memory that stores data contents. Both memory 904 and memory 906 are RAM which are used to store the possibly data accessed by processor core 112. Both memory 904 and memory 906 are divided into multiple data memory blocks, each of which may store at least a datum or more continuous data (i.e., data block). Memory 908 and memory 910 are CAM which are used to store address information corresponding to the above described data memory blocks. The described address information may be a start address of data block stored in the data memory block, or a part (the high bit part) of the start address, or any appropriate address information.

Memory 908 and 910 are also divided into multiple tag memory blocks, each of which stores the information of an address. The tag memory block in memory 908 and the data memory block in memory 904 are in one-to-one correspondence. The tag memory block in memory 910 and the data memory block in memory 906 are in one-to-one correspondence. Thus, the corresponding data memory block in memory 904 can be found by performing a matching operation with the address information in the memory 908. The corresponding data memory block in memory 906 can be found by performing a matching operation with the address information in the memory 910.

In certain embodiments, an input of selector 914 is data block 932 outputted by memory 904. Another input of selector 914 is prefetching data block 934. Selection signal is the result of address matching in data memory 106. The output is data block 936 that is sent to selector 930. If the matching operation for address 944 that is sent to data memory 106 is successful, the selector 914 selects the data block 932 outputted by memory 904 as the output data block 936. Otherwise, the selector 914 selects prefetching data block 934 as the output data block 936.

An input of selector 930 is data block 936 outputted by selector 914. Another input of selector 930 is data block 918 sent by processor core 112 for store operation. Selection signal is the signal that represents whether the current operation is store operation. An output of selector 930 is data block 938 that is sent to memory 906. If the current operation is store operation, the selector 930 selects the data block 918 sent by processor core 112 as the output data block 938. Otherwise, the selector 930 selects the data block 936 outputted by selector 914 as the output data block 938.

In addition, in certain embodiments, data fill unit 942 is used to generate prefetching data addressing address. The data fill unit 942 may be data predictor 110, look ahead module 608, a combination of these two modules, or any other appropriate data addressing address predict module.

When data fill unit 942 outputs a data addressing address 912 that is used to prefetch data, at the beginning, the data addressing address 912 is sent to selector 920, and then the result selected by selector 920 is outputted as the addressing address 922 to perform an address information matching operation with tag memory 910 in data read buffer 902. If the matching operation is successful, that is, the data corresponding to the address 912 is stored in memory 906 in data read buffer 902, no prefetch operation is performed. If the matching operation is unsuccessful, the address as the output address 944 is sent to tag memory 908 in data memory 106 to perform address information matching operations. Similarly, if the matching operation is successful, that is, data corresponding to the address 944 is stored in memory 904 in data memory 106, no prefetch operation is performed. The data block including the data is read out from the memory 904. After the data is selected by selector 914 and selector 930, the data is written to memory 906 and stored in data read buffer 902. If the matching operation is unsuccessful, the address is outputted as the output address 916 that is sent to fill engine 102 to perform a prefetch operation. An available data block memory location and the corresponding address information memory location are assigned in data read buffer 902.

If data read buffer 902 is full, a data block and the corresponding address information are moved out from data read buffer 902 based on certain replacement policy and stored in data memory 106 by bus 940. Similarly, if data memory 106 is full, a data block and the corresponding address information are moved out from data memory 106 based on certain replacement policy and sent to fill engine 102 to write back to main memory by bus 932. The described replacement policy may be least recently used (LRU) replacement policy, least frequently used (LFU) replacement policy, or any other appropriate replacement policy.

After the prefetched data block 934 including the data is selected by selector 914 and selector 930, it is written directly to the assigned location of memory 906 to store the data in data read buffer 902. Thus, the data corresponding to the predicted data addressing address is stored in data read buffer 902 for reading/writing when the data access instruction is executed by processor core 112.

When executing data load instruction, the data addressing address 924 sent by processor core 112 is sent to selector 920, and then the result selected by selector 920 is outputted as the addressing address 922 to perform a matching operation in data read buffer 902. If the matching operation is successful, that is, the data corresponding to the instruction is stored in data read buffer 902, the corresponding data block is found. And the low bit part of the data addressing address 924 selects the needed data 928 from outputted data block 926 to complete the data load operation. If the matching operation is unsuccessful, that is, the data corresponding to the instruction is not stored in data read buffer 902, the address as the output address 944 is sent to tag memory 908 in data memory 106 to perform address information matching operations. If the matching operation is successful, after the data block including the data read out from the memory 904 is selected by selector 914 and selector 930, the data block is written to memory 906. At the same time, it is sent to processor core 112 as data block 926. And the low bit part of the data addressing address 924 selects the needed data 928 from outputted data block 926 to complete the data load operation. If the matching operation is unsuccessful, the address is outputted as the output address 916 that is sent to fill engine 102 to perform a prefetch operation. After the prefetched data block 934 including the data is selected by selector 914 and selector 930, the data block is written directly to memory 906. The data block 934 as data block 926 is sent to processor core 112, and the low bit part of the data addressing address 924 selects the needed data 928 from outputted data block 926 to complete the data load operation. In such case, the reason that the data is not stored in data read buffer 902 may be data addressing address predict error in the previous operation (i.e., no prefetching the data), the data replaced from the data read buffer 902, or any other appropriate reason.

When executing data store instruction, the data addressing address 924 sent by processor core 112 is sent to selector 920, and then the result selected by selector 920 is outputted as the addressing address 922 to perform a matching operation in data read buffer 902. If the matching operation is successful, that is, the data corresponding to the instruction is stored in data read buffer 902, the position of the data in memory 906 is determined based on the result of the matching operation. Thus, after data 918 sent by CPU 112 is selected by selector 930, the result of the selection is written to memory 906 to complete the data store instruction. If the matching operation is unsuccessful, that is, the data corresponding to the instruction is not stored in data read buffer 902, an available data block memory location and the corresponding address information memory location are assigned in data read buffer 902. After data 918 sent by processor core 112 is selected by selector 930, the data is written to memory 906 to complete the data store operation.

Thus, the newest prefetched data is stored in data read buffer 902 for the access of processor core 112. Only the data replaced from data read buffer 902 may be stored in data memory 106. In practice, the capacity of data read buffer 902 may be relatively small to quickly access the processor core 112 and the capacity of data storage 106 may be relatively large to accommodate more data that processor core 112 may access. In addition, because most of data to be accessed by processor core 112 is stored in data read buffer 902, the number of accessing data memory 106 can be decreased, reducing power consumption.

FIG. 10 illustrates an exemplary data prefetching 1000 consistent with the disclosed embodiments. As shown in FIG. 10, structure and function of processor core 112, instruction memory 602, base address information memory 606, data memory 106, and data read buffer 902 is the same as the previous described embodiment. Structure of filter 432 is similar with filter 432 in FIG. 4. The filter 432 is used to store stride length of various base registers and output changing value of the corresponding stride 1046 based on inputting base register number.

Scanner 1002 may examine the instructions in the instruction memory 602, and extract some information, such as instruction type, base register number, base register stride value. Instruction type may include load instruction, store instruction, last updating register instruction, branch instruction, and other instructions. Instruction type information is stored as a row format in instruction type memory 1010, and the base register number, stride length, and other information are stored in base address information memory 606. In addition, address offset using an immediate value format in the instruction (such as data access address offset, branch target address offset, etc.) is stored directly in instruction information memory 1008.

Tracker 1004 may find next data access instruction based on the instruction type outputted by instruction type memory 1010. Thus, base address information memory 606 and instruction information memory 1008 are addressed by the address of the data access instruction outputted by read pointer 1018. In certain embodiments, if the instruction type is ‘1’ and ‘0’ represents the data access instruction and no-data access instruction, respectively, a row including ‘1’ and ‘0’ stored in instruction type memory 1010 represents the corresponding instruction type. In addition, if the instruction type whose instruction address is small is on the left and the instruction type whose instruction address is large is on the right, that is, the access order of various instruction types is from left to right when executing these instructions in order.

Tracker 1004 mainly includes a shifter 1020, a leading zero counter (LZC) 1022, an adder 1024 and a register 1026. The shifter 1020 shifts plural instruction type 1028 that represents a plurality of instructions read out from instruction type memory 1010 to the left, and the number of its movement is determined by read pointer outputted by register 1026 in the tracker 1004. The most left bit of the shifted instruction type 1030 outputted by shifter 1020 is a step bit. Both a signal of the step bit and a signal 1032 from processor core determine to update register 1026.

Instruction type 1030 is sent to LZC 1022 to calculate the number of instruction type ‘0’ (an instruction type represents no-data access instruction) before the next instruction type ‘1’ (an instruction type represents data access instruction). The number is calculated to be one ‘0’ regardless of step number that is ‘0’ or ‘1’. The leading ‘0’ step number 1034 that is sent to the adder 1024 is added to pointer value 1018 outputted by register 1026 to the next data access instruction address 1016. One or more no-data access instructions before the next data access instruction are skipped by tracker 1004.

When read pointer of tracker 1004 points to an entry of next instruction, the shifter controlled by the read pointer shifts the plural instruction types outputted by memory 1010 to the left. At this time, the instruction type of the instruction that read out from memory 1010 is shifted to the most left step bit of instruction type 1030. The shift instruction type 1030 is sent to LZC 1022 to calculate the number of the instructions before next data access instruction. The output 1034 of LZC 1022 is a forward step of tracker 1004. Next data access instruction address 1018 is obtained by adding the forward step to an output of register 1026 by adder 1024.

If a signal of the step bit of shifted instruction type 1030 is ‘0’, an entry of memory 110 pointed by the read pointer of tracker 1004 represents no-data access instruction. Thus, the signal of the step bit controls the update of register 1026. At this time, a new read pointer points to the next data access instruction in the same track. One or more no-data access instructions before the data access instruction are skipped. The new read pointer controls shifter 1020 to shift instruction type to the step bit of shift instruction type 1030 for next operation.

If a signal of the step bit of shifted instruction type 1030 is ‘1’, an entry of memory 110 pointed by the read pointer of tracker 1004 represents a data access instruction. At this time, the signal of the step bit does not affect the update of register 1026. Signal 1032 sent by processor core controls the update of register 1026. Thus, the output 1016 of adder 1024 is the address of the next data access instruction in the same track of the current data access instruction. One or more no-data access instructions before the data access instruction are skipped. The new read pointer controls shifter 1020 to shift instruction type to the step bit of shift instruction type 1030 for next operation. Tracker 1004 may skip one or more no-data access instructions in the track table and always point to data access instructions in the same pattern.

When processor core 112 executes the data access instruction, instruction information memory 1008 outputs the corresponding contents based on read pointer 1018, that is, address offset 1036 corresponding to the data access instruction. The needed data addressing address 1040 of the data access is obtained by adding address offset 1036 to address register value 1038 corresponding to the base data access instruction sent by processor core 112 by adder 1024. Because the current instruction being executed by the processor core is a data access instruction, selector 1016 selects data addressing address 1040 as an output address 1042 that is sent to data read buffer 902 to match address information. The following process follows the described pattern in previous embodiments to obtain data corresponding to the data addressing address.

At the same time, data addressing address 1040 that is also sent to adder 1014 and stride length of base register value 1046 sent by filter 432 are inputted to perform the operation of addition. Thus, adder 1014 may output next possible data addressing address 1050 to selector 1016. When the current instruction executed by processor core is not a data access instruction, selector 1016 selects the possible data addressing address 1050 to data read buffer 902 to match with address information. The following process follows the described pattern in previous embodiments to prefetch data corresponding to the data addressing address.

When completing data access instruction, control signal 1032 that is sent from processor core 112 to tracker 1004 represents that the data access instruction is completed. Therefore, the position of next two data access instruction (the second instruction) outputted by adder is written to register 1026 to stop the second data access instruction pointed by read pointer 1018. The following operations follow the described same pattern.

In certain embodiments, data addressing address 1040 corresponding to the executing data access instruction and possible data addressing address 1050 corresponding to the data access instruction to be executed next time are generated outside processor core 112. After these two instructions are selected by selector 1016, the result of the selection is sent to data read buffer 902 to match with address information in order to obtain the corresponding data segment 1054. Therefore, processor core 112 only outputs offset address 1052 (low bit part of the data addressing address) of the needed data in the data segment to select the needed instruction from data segment 1054.

### INDUSTRIAL APPLICABILITY

The disclosed systems and methods may be used in various applications in memory devices, processors, processor subsystems, and other computing systems. For example, the disclosed systems and methods may be used to provide low cache-miss rate processor applications, and high-efficient data processing applications crossing multiple levels of caches or even crossing multiple levels of networked computing systems.

### SEQUENCE LISTING FREE TEXT

### Sequence List Text

1. A method for facilitating operation of a processor core coupled to a first memory containing data and a second memory with a faster speed than the first memory, and configured to execute a segment of instructions having at least one instruction accessing the data from the second memory using a base address, the method comprising:
examining instructions to generate stride length of base register value corresponding to every data access instruction;
calculating a possible data access address of a data access instruction to be executed next time based on the stride length of base register value; and
filling data stored in the first memory to the second memory based on the calculated possible data access address of the data access instruction to be executed next time.

2. The method according to claim 1, further including:
calculating the possible data access address for the data access instruction to be executed again, and filling the data from the first memory to the second memory.

3. The method according to claim 1, wherein:
a current base register value corresponding to the data access instruction being executed minus a previous base register value corresponding to the data access instruction executed last time to obtain stride length of base register value.

4. The method according to claim 1, wherein:
a change value of base register is extracted and added up from every instruction updating the base register value when the instruction is examined for every base register to obtain stride length of base register value when a same data access instruction is executed twice.

5. The method according to claim 1, wherein:
a different number of prefetching operations are assigned based on access memory latency and a branch range of the data access instruction.

6. A method for facilitating operation of a processor core coupled to a first memory containing data and a second memory with a faster speed than the first memory, and configured to execute a segment of instructions having at least one instruction accessing the data from the second memory using a base address, the method comprising:
examining the segment of instructions to extract instruction information containing at least data access instruction information and last base register updating instruction information; and
filling data from the first memory to the second memory based on a track corresponding to the segment of instructions after execution of an instruction last updating the base register used by the at least one instruction accessing the data.

7. The method according to claim 6, wherein:
moving a data pointer through the segment of instructions to extract the instruction information with a faster speed than a current pointer pointing to an instruction currently being executed by the processor core; and
stopping at the at least one data access instruction.

8. The method according to claim 7, wherein:
a distance between the base register value instruction in a last updating data access instruction and the data access instruction is recorded in an entry corresponding to the data access instruction in a track table to determine the time point of the updated base register.

9. The method according to claim 6, wherein:
when getting to the time point for calculating data addressing address, the data addressing address is calculated by adding an address offset to the base register value.

10. The method according to claim 9, wherein:
base register value is obtained by an extra read port of a register in the processor core.

11. The method according to claim 9, wherein:
base register value is obtained by a time multiplex mode from a register in the processor core.

12. The method according to claim 9, wherein:
base register value is obtained by a bypass path in the processor core.

13. The method according to claim 9, wherein:
base register value is obtained by an extra register file for data prefetching in the processor core.

14. A method for facilitating operation of a processor core coupled to a first memory containing data, a second memory with a faster speed than the first memory and a third memory with a faster speed than the second memory, and configured to execute a segment of instructions having at least one instruction accessing the data from the third memory, the method comprising:
examining instructions to generate stride length of base register value corresponding to every data access instruction;
calculating a possible data access address of the data access instruction to be executed next time based on the stride length of base register value;
prefetching data and storing the data in the third memory based on the calculated possible data access address of the data access instruction to be executed next time;
storing data that moved out from the third memory in the second memory because the content is replaced from the third memory; and
writing back the data that moved out from the second memory to the first memory because the content is replaced from the second memory.

15. The method according to claim 14, wherein:
the processor core accesses directly the data in the third memory.

16. A system for facilitating operation of a processor core coupled to a first memory containing data and a second memory with a faster speed than the first memory, and configured to execute a segment of instructions having at least one instruction accessing the data from the second memory using a base address, the system comprising:
examining instructions to generate stride length of base register value corresponding to every data access instruction;
calculating a possible data access address of the data access instruction to be executed next time based on the stride length of base register value; and
prefetching data and filling the data in the first memory to the second memory based on the calculated possible data access address of the data access instruction to be executed next time.
